(19) United States
(12) Patent Application Publication
(10) Pub. No.: US 2015/0230495 A1
(43) Pub. Date: Aug. 20, 2015

(54) GUM BASES AND CHEWING GUMS EMPLOYING BLOCK POLYMERS AND PROCESSES FOR PREPARING THEM

(71) Applicants: WM. WRIGLEY JR. COMPANY, Chicago, IL (US); REGENTS OF THE UNIVERSITY OF MINNESOTA, Minneapolis, MN (US)

(72) Inventors: Les Morgret, Chicago, IL (US); Frank S. Bates, Saint Louis Park, MN (US); Marc A. Hillmyer, Minneapolis, MN (US); Songwoo Lee, Minneapolis, MN (US); Chris Macosko, Minneapolis, MN (US); Mark T. Martello, Saint Paul, MN (US)

(21) Appl. No.: 14/426,199

(22) PCT Filed: Sep. 6, 2013
(86) PCT No.: PCT/US13/58394

§ 371 Date: Mar. 5, 2015

Related U.S. Application Data
(60) Provisional application No. 61/698,327, filed on Sep. 7, 2012.

(51) Int. Cl. A23G 4/08

(52) U.S. Cl. CPC A23G 4/08; A23V 2002/00

(57) ABSTRACT

Chewing gums and chewing gum bases which are cud-forming and chewable at mouth temperature contain a block polymer having at least four blocks Composed of at least two different monomer systems. The block polymer exhibits an Order-Disorder Transition temperature in the range of 10 to 250° C. Chewed cuds of the chewing gum may exhibit improved removability from environmental surfaces to which they may become undesirably attached. A processing method in which the gum is mixed and/or sheeted at a temperature above the Order-Disorder Transition temperature is described.

### PRIORITY DATA

The present patent application is a 371 of International Application No. PCT/US13/58394 filed Sep. 6, 2013, pending, which claims benefit from U.S. Ser. No. 61/698,327 filed Sep. 7, 2012, expired. All of the patent applications listed above are incorporated by reference therefrom as if fully restated herein

### BACKGROUND OF THE INVENTION

The present invention relates to chewing gum. More specifically, this invention relates to improved formulations for chewing gum bases and chewing gums containing block polymers having an Order-Disorder Transition temperature in the range of 20° C. to 250° C. The invention further includes a process in which chewing gum components including at least one block polymer having an Order-Disorder Transition temperature in the range of 20° C. to 250° C. are mixed and/or formed at a temperature above the Order-Disorder Transition temperature and then optionally tempered at a temperature below the Order-Disorder Transition temperature. Chewing gums prepared according to the invention have improved dimensional stability during and after forming and may produce chewed cuds which have improved removability when attached to environmental surfaces.

### SUMMARY OF THE INVENTION

This invention is directed to chewing gum bases comprising a block polymer comprising at least four blocks and having an Order-Disorder Transition temperature (T_{ODT}) between 20° C. and 250° C.

In some embodiments, the present invention provides a process for preparing a chewing gum product containing the above described block polymer. In the process, chewing gum components including the block polymer—either as a separate component or in the form of a pre-mixed gum base—are blended at a temperature above the T_{ODT}. After blending, the temperature is maintained—or reheated to—above the T_{ODT} while the blended gum mass is formed into a final product shape such as sticks, tabs or pellets. The formed gum pieces may then be tempered at a temperature below the T_{ODT} before further processing such as coating or packaging.

### BRIEF DESCRIPTION OF THE DRAWINGS

FIG. 1 is SAXS patterns of L₆D₁₀ diblock, (L_{4.4}D₁₇L_{4.4})ₙ multi-block and a blend with 90% diblock polymer.

FIG. 2 is SAXS patterns of LDL triblock polymers taken at room temperature.

FIG. 3 is SAXS patterns of (LDL)ₙ multi-block polymers taken at room temperature.

FIG. 4 is a SAOS isochronal temperature sweeps (heating) FIGS. 4a and 4b: SAOS: Isochronal temperature sweeps (heating) of LDL Prepolymers (4a) and multiblock copolymers resulting from Chain-Extension of the Prepolymers (4b).

FIG. 5 is a SAOS: Isothermal frequency sweep of (L_{2.2}D_{9.1}L_{2.2})ₙ taken at 90° C. exhibiting solid like behavior and at 150° C. where terminal behavior is observed at low frequencies. 1% strain

FIG. 6 is a SAOS: Isothermal frequency sweep of (L_{2.2}D₁₂L_{2.2})ₙ taken at 150° C. exhibiting terminal behavior. 1% strain.

### DESCRIPTION OF THE INVENTION

The present invention provides improved chewing gum bases and chewing gums. In accordance with the present invention, novel chewing gum bases and chewing gums are provided that include a block polymer having at least four blocks composed of at least two different monomer systems. The term monomer system refers to the molecular constitution of a polymeric block which may itself be a homopolymer or an alternating or random copolymer.

Conventional chewing gum bases typically consist of linear, amorphous polymers with glass transition temperatures around or below body temperature, Since glass transition is quasi-second order thermodynamic transition, the dimension of chewed gum cuds is the function of both time and temperature, which make gum cuds behave like a slow-flowing viscous mass at ambient temperatures, causing the cud to flow into pores and crevices in environmental surfaces. This flow over time results in the development of intimate contact area between gum cud and substrate during aging, which results in strong adhesion to the surface. Energy applied on the gum cud in an effort to remove it is dissipated on the way to the interface between gum cud and the substrate. This results in much higher energy required for complete removal.

Block polymers (which are also referred to as block copolymers) comprise linear polymeric segments (blocks) each having a molecular weight of at least a few hundred daltons. In the present invention, the block polymer will have at least four such blocks alternating between the different monomer systems. For example, the block polymer may have the form A-B-A-B or A-B-C-A or A-B-C-D where A, B, C and D are blocks having different monomer systems.

In some embodiments, the block polymer will have a structure which may be designated as (A-B)ₙ or (A-B-C)ₙ in the cases where there are two or three different polymeric blocks (respectively) repeated n times. It is possible that the repeating sequence may include more than one polymeric block of the same monomer system, for example (A-B-A)ₙ. In such cases, the A blocks contained within the chain will effectively be twice as long as A blocks at the end of the chain, for example A-B-A-A-B-A-A-B-A in the case where n=3. In some embodiments, the block polymer may be prepared by linking diblock or triblock or longer multi-block polymers together using a linking unit. For example, two A-B diblock polymers might be linked together to form a tetra block polymer having the form A-B-x-A-B where x is the linker unit.

In some embodiments, the blocks will be at least three monomer system units in length. In some embodiments, the blocks will be at least ten monomer system units in length. In some embodiments, the blocks will be at least twenty monomer system units in length. In some embodiments, the blocks will be at least fifty monomer system units in length.

In some embodiments the block polymer will have a molecular weight (Mₙ) of at least 5,000 daltons or at least 10,000 daltons or at least 50,000 daltons or at least 100,000 daltons or at least 200,000 daltons or even at least 500,000 daltons. Unless otherwise specified, all molecular weights will refer to number average molecular weights, Mₙ determined by Gel Permeation Chromatography or by NMR Spectroscopy or by GPC-MALLS (multi-angle laser light scattering).

The block copolymers useful in the present invention will have an Order-Disorder Transition temperature (T_{ODT}) between 20° C. and 250° C. In some embodiments, the block copolymer will have a T_{ODT} below 200° C. or below 180° C. or below 160° C. or below 140° C. or below 120° C. or preferably below 100° C. or below 90° C. or below 80° C. or below 70° C. or below 60° C. or below 50° C. or even below 40° C. In at least some embodiments, the block copolymer will have a T_{ODT} above 20° C. or above 25° C. or above 30° C. or above 35° C.

Block polymers of the type described are known to form phase segregated secondary structures or micro-domains which can provide a degree of rigidity to the polymeric mass. The ability to form such structures is a function of thermodynamic incompatibility of the monomer systems and the size of the blocks. Monomer systems having a greater degree of thermodynamic incompatibility and larger blocks are more conducive to forming the micro-domains. These domains form when the block polymer is maintained at a sufficiently low temperature for a period of time. However, upon heating to a sufficient temperature, the structure may be lost and the block polymer can be said to be in a disordered state. Upon cooling, the copolymer will again form the micro-domains and is said to be ‘ordered’. The temperature above which the block polymer will always be disordered and below which the block polymer may form these micro-domains is called the Order-Disorder Transition temperature or T_{ODT}.

The relevant T_{ODT} in the present invention may either be the inherent T_{ODT} of the multiblock polymer itself, or the effective T_{ODT} of the polymer resulting from the action of any modifier which may alter the T_{ODT} as used in the gum base and chewing gum. Unless otherwise specified, the term T_{ODT} as used herein refers to either the inherent T_{ODT} or the effective T_{ODT}.

The thermodynamic incompatibility of the blocks is expressed as a value, χ (chi), with higher values corresponding to greater thermodynamic incompatibility. Values for χ can be difficult to calculate and the value is often inferred from rheological testing or Small Angle X-Ray Scattering which show the presence of ordering in a block polymer.

At low temperatures, the block polymers useful in the present invention will form domains which exist in a glassy state. As the temperature rises, these domains may assume a viscoelastic state. The temperature at which this occurs is referred to as the glass transition temperature or T_{g}. The polymer may have two or more T_{g}'s as different blocks form domains that crystallize at different temperatures. With further heating, the crystalline structure dissociates and the domain assumes a liquid or amorphous solid state. The temperature at which this occurs is the Melting Point or Tₘ. Again there may be multiple Tm's as different crystalline regions melt. Even at this point, the polymer will be in an ordered state until the temperature reaches the T_{ODT} at which point the polymer becomes disordered.

The micro-domains formed by the block polymers in the present invention convey certain benefits to chewing gums formulated to contain them. They provide desirable elasticity during chewing. Moreover, if a chewed cud is improperly discarded and adheres to a rough environmental surface—most commonly a concrete sidewalk—the micro-domains prevent or reduce flow into the pores and cervices of the concrete making the cud easier to remove. This assumes that the cud is at or below the T_{ODT}.

However, the same micro-domains can cause problems during manufacture. For example, the cohesive nature of the structure increases the load on the gum mixer used to blend the block polymer (or the base containing it). Mixing (blending) the components at a temperature above T_{ODT} reduces the load on the mixer thereby reducing power requirements, energy consumption and stress on the mechanical components for longer mixer life and/or greater mixer capacity. By selecting a block polymer with a lower T_{ODT}, these benefits can be achieved at preferred mixing temperatures.

Even more problematical is the tendency of the mixed gum mass to spring back and resist efforts to form it into a final product shape. Chewing gum pieces are typically formed by sheeting the gum mass between rollers to reduce it to a desired thickness, then using blades (typically mounted on rollers) to cut or pinch the sheet into the desired piece dimensions. This forms the gum into sticks, tabs or pellets. It is common for the cutting or pinching to be less than complete, leaving the pieces joined at their periphery. In the case of pellets the joint is a thin strip of gum called a land. The result is a sheet of sticks, tabs or pellets which can later be separated into individual pieces. For purposes of the present invention, the production of such a scored sheet is considered to be forming the gum into its final product shape. Similarly, in the case of coated pellets, forming the gum mass into pellets or a scored sheet of pellets prior to coating will constitute forming the gum into its final product shape. Alternatively, the gum mass can be extruded as a rope which is then cut to desired length to form chunks. In a variation, the gum may be coextruded as a filled rope and pinched to form a filled piece or a segmented or beaded rope or chain of such pieces. In all such cases, the shaping of the product may advantageously be performed at a temperature above the T_{ODT} of the block polymer in accordance with the method of the present invention.

Yet another alternative forming method in which the gum mass is compression molded or cast at temperatures much higher than the T_{ODT}. This allows the forming of the product into more complex and exotic shapes such as animal or toy shapes.

Forming the chewing gum mass into a final product shape at a temperature above the T_{ODT} of the block polymer reduces or eliminates the tendency of the gum piece to spring back after forming. This allows more precise shaping and sizing of the pieces. Such precision is important not only for consistency in appearance but also to allow efficient, automated handling of the product, for example, in packaging.

Typically, chewing gum base is mixed at 100 to 140° C. Chewing gum is typically mixed at 40 to 70° C. The forming process is typically performed at 30 to 70° C. Although it is possible, within limits, to raise mixing and forming temperatures sufficiently to force the polymer into its disordered state, it is preferable to select a block polymer having a T_{ODT} sufficiently low to allow maintenance of common processing temperatures. Typically, this means that the monomer units and block lengths will be selected to produce a degree of incompatibility sufficiently great to produce a well defined T_{ODT}, but not so great that the is significantly higher than the desired processing temperatures.

T_{ODT} of the block polymer can be determined by Dynamic Mechanical Analysis (DMA) which is also called Dynamic Mechanical Spectroscopy (DMS). This technique consists of a rheological characterization which can be performed, for example, using a TA Instruments ARES-G2 to make isochronal measurements within the linear viscoelastic regime using 1% strain amplitude and a frequency of 1 rad/s (maximum) while heating the sample at the rate of 1° C./min (maximum). The T_{ODT} (if present) is determined by observing the temperature of a discontinuous drop in the dynamic elastic modulus (G′). Further details of this type of analysis can be found in Fredrickson and Bates Ann. Rev Mater. Sci 1996, 26, 501-550 and in Rosedale and Bates, Macromolecules 1985, 18, 67-78. In some cases the discontinuity in the G′ plot will be sudden allowing and easy determination of the T_{ODT}. In other cases, the G′ transition may be manifested over a relatively broad temperature range. In such cases, T_{ODT} can be further refined by isothermal frequency sweep measurements or small angle X-ray scattering experiments. T_{ODT} can also be measured using electron microscopy such as Transmission Electron Microscopy (TEM) to visualize the phase segregation as the sample is heated.

In some embodiments the block polymer useful in the present invention will have at least two soft polymeric blocks and at least two hard polymeric blocks. For purposes of this invention, soft polymeric blocks are those amorphous polymeric block which have a glass transition temperature (Tg) which is below mouth or body temperature such as below 37° C., or below 35° C., or below 30° C., or below 15° C., or below 0° C., or below −10° C. or even below −20° C. Soft polymeric blocks could also be semicrystalline polymeric block with both glass transition temperature (Tg) and melting point below mouth or body temperature such as below 37° C., or below −10° C. or even below −20° C. This insures that the soft block will be in an amorphous state during chewing. This is important to provide elasticity to the polymer.

In some embodiments the block polymers useful in the present invention will have a T_{ODT} which is less than 30° C. higher than the highest T_{g} of the polymer. In some embodiments, the T_{ODT} will be less than 20° C., or less than 10° C., or less than 5° C. higher than the highest T_{g}.

The polymeric blocks which make up the block polymers of the present invention may comprise soft polymers, hard polymers or a mixture of both. By soft polymer, it is meant that the block is composed of a polymer having a glass transition temperature substantially below mouth temperature. (For purposes of the present invention, a polymer's glass transition temperature is taken to mean the glass transition temperature of that polymer in a high molecular weight form such as 200,000 daltons, even in cases where only shorter blocks are present in the block polymer. This concept is commonly expressed as T_{g}^{∞}.) Specifically, soft polymers will typically have a T_{g} below 20° C. or below 10° C. or even below 0° C. Soft polymers will also have a complex shear modulus between 10³ and 10⁸ Pascals at 37° C. and 1 rad/sec. Preferably, the shear modulus will be between 10⁴ and 10⁷ more preferably between 5×10⁵ Pa and 5×10⁶ Pa at 37° C. and 1 rad/sec. Examples of soft polymers include homopolymers of isoprene, homopolymers of 6-methylcaprolactone, poly(6-butyl-ε-caprolactone), polymers of alkyl or aryl substituted lactones, polymers of alkyl or aryl substituted ε-caprolactones, polymers of alkyl or aryl substituted ε-decalactones, polydimethylsiloxane homopolymers, polybutadiene, polycyclooctene, polyvinyllaurate. In some embodiments, a soft polymeric block may be a random or alternating copolymer. Generally, soft polymeric blocks will be non-crystalline at typical storage and mouth temperatures. However, in some cases a soft polymeric block may have some semi-crystalline domains.

In contrast, by hard polymeric blocks it is meant that the block(s) comprise essentially identical polymers or compatible or incompatible polymers having a T_{g}. above about 20° C. or above 30° C. or even above 40° C. It is also important that the hard polymer(s) have a T_{g} sufficiently low as to allow convenient and efficient processing, especially when the block polymer or block polymer elastomer system is to be used as the sole component in a gum base. Thus the hard polymer(s) should have a T_{g} below 70° C. and preferably below 60° C. Use of hard polymers having glass transition temperatures in this range allows lower processing temperatures, reduced mixing torque and shorter mixing times. This results in energy savings and effectively increased mixing capacity. Examples of hard polymers useful in the present invention include homopolymers of D,L-lactide, polylactic acid homopolymers, homopolymers of vinylacetate, poly(ethylene terephthalate) homopolymers, homopolymers of glycolic acid and poly(propyl methacrylate). Hard polymeric blocks may be random or alternating or graft copolymers such as a random or alternating or graft copolymer of glycolic acid and lactic acid. Typically, random or alternating hard polymeric blocks will be amorphous or semi-crystalline at storage and chewing temperatures.

In some embodiments soft and hard polymeric blocks which are incompatible with each other will be used to form the block polymer to maximize the formation of microphase separation internal structures.

In some cases, the block polymer may exhibit only a single glass transition temperature. This may be due to the small size of the blocks or the small total amount of individual monomers in the block polymer. Or they may be due to the different blocks being miscible together or having very similar T_{g}s. In other cases, two or more glass transitions may be observable. In some embodiments of the present invention the block polymer will exhibit at least two glass transition temperatures, the highest being between 20° C. and 70° C. (preferably between 30° C. and 50° C.) and at least one being less than 40° C. or less than 30° C. or less than 20° C. or less than 10° C. or less than 0° C. or even less than −10° C. It is believed that such a polymer, when combined with any softeners and plasticizers in the gum base, will offer a desirable combination of easy processing, good chewing texture and good removability when the surface from which the cud is to be removed is or lower than the T_{ODT} of the block polymer. It is expected that the block polymer could be ‘tuned’ through selection of the monomer systems or incorporation of plasticizers added to the base, or both, to reduce the glass transition temperatures such that the highest T_{g} will be below mouth temperature (about 35° C.) and at least one T_{g} will be below the expected temperature of concrete or other adhered substrate during the removal process. The optimal glass transition temperatures will depend on the amount and effectiveness of the plasticizers incorporated into the gum base (if any.)

Examples of polymers which are suitable for forming the soft polymeric blocks include polyisoprene, poly(6-methylcaprolactone), poly(6-butyl-ε-caprolactone (also known as poly(ε-decalactone), other polymers of alkyl or aryl substituted ε-caprolactones, polydimethylsiloxane, polybutadiene, polycyclooctene, polyvinyllaurate, polymenthide, polyfarnesene, polymyrcene, random copolymers prepared from comonomer pairs consisting of alkene pairs such as ethene/1-octene and ethene/butene, alkene-vinylalkanoate pairs such as ethene/vinylacetate, different hydroxyalkanoate hydroxybutyrate/hydroxyhexanoate, hydroxybutryate/hydroxyvalerate and hydroxybutyrate/hydroxyoctanoate alkene-acrylate pairs such as ethene/butylacrylate, lactones/lactide pairs such as caprolactone/L-lactide and alkylene oxide pairs wherein at least one of the alkylene oxides has a carbon chain having at least three carbons such as ethylene oxide/propylene oxide and methylene oxide/propylene oxide.

In some embodiments, a linking unit, designated X, may be present between some or all of the repeating sequences. Thus the block polymer may be designated as (A-B-X)ₙ or (A-B-A-X)ₙ in the case where there are a total of n sequences of two repeating blocks where a linking unit is located between each repeating sequence. Suitable linking agents are capable of connecting polymer blocks via covalent chemical bonding and may provide for inter- and intramolecular non-covalent bonding, such as hydrogen bonding or dipolar interaction. Examples of linking agents which may be useful in the present invention include urethanes, esters, amides, carbonates, carbamates, urea, dialkylsiloxy- and diarylsiloxy-based units, ethers, thioethers and olefins. Urethane-based units may optionally include urea structures. Specific linking agents which may be useful in the present invention include adipoyl chloride (ACI), terephthaloyl chloride (TCI), divinyl adipate (DVA), methylene bisphenyl diisocyanate (MDI), toluene diisocyanate (TDI), Isophorone diisocyanate (IPDI) and Hexamethylene diisocyanate (HDI).

The linking unit may be used to extend the length of the block, thereby increasing its elastomeric properties. In some embodiments it will be desirable to build the block chain up to a molecular weight (Mₙ) of at least 26,000 or at least 40,000 or at least 80,000 or at least 90,000 g/mole. In some embodiments, it will be desirable to build the block chain up to a maximum molecular weight (Mₙ) of 80,000 or 150,000 or 200,000 or 400,000 or 700,000 g/mole. A weight average molecular weight (M_{w}) 80,000 to 700,000 g/mole or preferably 90,000 to 150,000 g/mole is also appropriate.

Alternatively, the technique of chain shuttling polymerization may be used to prepare the block polymer chain.

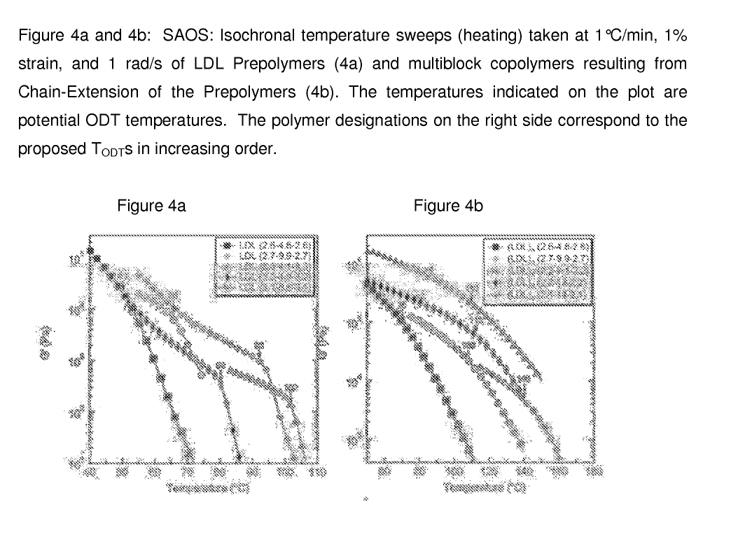

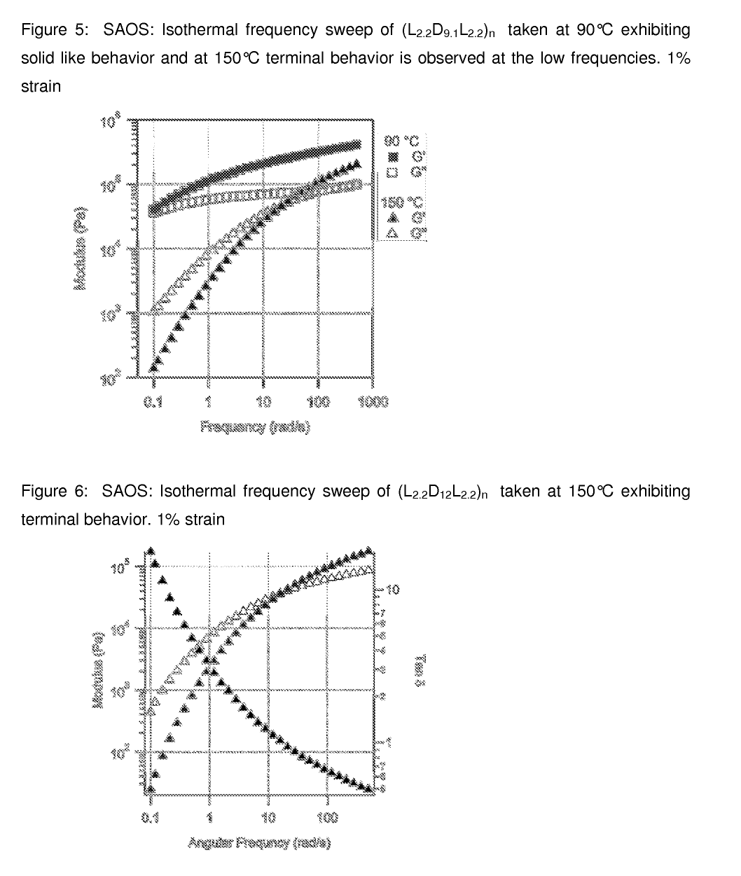

Controlling the T_{ODT} of the block polymer may entail controlling the overall molecular weight of the block polymer, the molecular weights of the incompatible blocks (A, B, C), and/or the molecular weights of the prepolymer segments (A-B-X, A-B-C-X) within the block polymer as well as selection of monomer systems. Lower molecular weight block polymers, blocks, and segments tend to produce lower T_{ODT}s. In the case of poly(lactide)-poly(decalactone) block polymers, these effects and some specific examples of different block and segment lengths and their effect on T_{ODT} can be seen in FIGS. 4a and 4b. For other monomer combinations, different molecular weights may be necessary to achieve T_{ODT}s in the desired range. Another means of controlling the effective T_{ODT} of the block polymer is through the selection and usage level of modifiers such as diblocks, triblocks and other plasticizers in the gum/gum base composition.

In the present invention, at least two of the at least four polymeric blocks will be immiscible with each other. In some embodiments, at least some of the polymeric blocks will have a glass transition temperature (T_{g}) of less than 70° C., or less than 60° C. or less than 50° C., or less than 40° C. In some embodiments, the different polymeric blocks will have significantly different glass transition temperatures from each other to enhance the elastomeric properties of the block copolymer.

By manipulating the overall molecular weight, the size and monomer composition of the polymer blocks, the number of the repeating sequences and the presence and frequency of non-covalent crosslinking groups, a product developer may produce a block polymer having the best combination of chewing texture, removability and processing properties. In some cases, the polymer may be tuned for specific chewing gum compositions, using different parameters for different flavors to compensate for different degrees of plasticization by the flavors. In other cases, the polymer may be “tuned” for a particular marketplace to account for differences in local climate and consumer preferences. The block copolymer may also be tuned to maximize removability of chewed cuds form environmental surfaces by promoting the formation of microphase separation internal structures as previously discussed.

A wide variety of gum base and chewing gum formulations including the block polymers of the present invention can be created and/or used. In some embodiments, the present invention provides for gum base formulations which are conventional gum bases that include wax or are wax-free. In some embodiments, the present invention provides for chewing gum formulations that are low or high moisture formulations containing low or high amounts of moisture-containing syrup. Low moisture chewing gum formulations are those which contain less than 1.5% or less than 1% or even less than 0.5% water. Conversely, high moisture chewing gum formulations are those which contain more than 1.5% or more than 2% or even more than 2.5% water. The block copolymers of the present invention can be used in sugar-containing chewing gums and also in low sugar and non-sugar containing gum formulations made with sorbitol, mannitol, other polyols (sugar alcohols), and non-sugar carbohydrates.

In some embodiments, a block polymer of the present invention may be used as the sole elastomer. In other embodiments it will be combined with other base elastomers for use in chewing gum base. Such other elastomers, where used, include synthetic elastomers including polyisobutylene, isobutylene-isoprene copolymers, styrene-butadiene copolymers, polyisoprene, polyvinylacetate, polyterpene resin, triglyceride of fatty acids and microcrystalline wax, emulsifiers such as mono-di glycerides and lecithin. Natural elastomers that can be used include natural rubbers such as chicle and proteins such as zein or gluten and modified starches such as starch laureates and starch acetates. In some embodiments, the block polymers may be blended with removable or environmentally degradable polymers such as polylactides, and polyesters prepared from food acceptable acids and alcohols. It is important that the block polymers of the present invention be food grade. While requirements for being food grade vary from country to country, food grade polymers intended for use as masticatory substances (i.e. gum base) will typically have to meet one or more of the following criteria. They may have to be specifically approved by local food regulatory agencies for this purpose. They may have to be manufactured under “Good Manufacturing Practices” (GMPs) which may be defined by local regulatory agencies, such practices ensuring adequate levels of cleanliness and safety for the manufacturing of food materials. Materials (including reagents, catalysts, solvents and antioxidants) used in the manufacture will desirably be food grade (where possible) or at least meet strict standards for quality and purity. The finished product may have to meet minimum standards for quality and the level and nature of any impurities present, including residual monomer content. The manufacturing history of the material may be required to be adequately documented to ensure compliance with the appropriate standards. The manufacturing facility itself may be subject to inspection by governmental regulatory agencies. Again, not all of these standards may apply in all jurisdictions. As used herein, the term “food grade” will mean that the block polymers meet all applicable food standards in the locality where the product is manufactured and/or sold.

In some embodiments of this invention, the block polymer is combined with a diblock and/or triblock polymer comprising polymer blocks which are individually compatible with at least two of the blocks which make up the larger block polymer. In these embodiments, the smaller block polymer acts as a modifier to the larger block polymer to provide an elastomer system which is consistent with the chew properties of conventional elastomer/plasticizer systems. For purposes of the present invention, the term, ‘modifier’ will refer to a material which modifies the physical or thermal properties such as viscosity, melting point, or T_{g} of the elastomeric block copolymer, for example by acting as a plasticizer or by reducing its crystallinity. The smaller block polymer may also provide additional benefits such as controlling release of flavors, sweeteners and other active ingredients, and reducing surface interactions of discarded cuds for improved removability from environmental surfaces. Furthermore, the di- and/or tri-block polymer may better help maintain the microphase separation structures in the block polymer as compared to other plasticizers.

By compatible, it is meant that the component polymer blocks (when separate from the multi-block or diblock configuration) have a chemical affinity and can form a miscible mixture which is homogeneous on the microdomain scale. This can normally be determined by a uniform transparent appearance. In cases where uncertainty exists, it may be helpful to stain one of the polymers in which case the mixture will, when examined with microscopic methods, have a uniform color if the polymers are compatible or exhibit swirls, a mottled appearance or other contrast on a nanometer length scale if the polymers are incompatible. Compatible polymers typically have similar solubility parameters as determined empirically or by computational methods. In preferred embodiments, at least two of the at least two polymer blocks which comprise the block polymer will be essentially identical to those of the diblock polymer to ensure the greatest possible compatibility. Further information on polymer compatibility may be found in Kraus Pure & Appl. Chem, 1986, Vol 58, No. 12, pp1553-1560 which is incorporated by reference herein.

In some embodiments, the block polymers of the present invention are elastomeric at mouth temperature in the sense of having an ability to be stretched to at least twice of an original length and to recover substantially to such original length (such as no more than 150%, preferably no more than 125% of the original length) upon release of stress. Preferably, the block polymer will also be elastomeric at room temperature and even lower temperatures which may be encountered in the outdoor environment. Preferably, the block polymer will be moderately elastomeric at mouth temperature, but highly elastic at cooler environmental temperatures.

In preferred embodiments of the present invention, cuds formed from gum bases containing block polymers are readily removable from concrete if they should become adhered to such a surface. By readily removable from concrete, it is meant that the cuds which adhere to concrete can be removed with minimal effort leaving little or no adhering residue. For example, readily removable cuds may be removable by use of typical high pressure water washing apparatuses in no more than 20 seconds leaving no more than 20% residue based on the original area covered by the adhered cud. In some cases, a readily removable cud may be peeled off of a concrete surface by grasping and pulling with fingers leaving no more than 20% residue by area of the original cud. Alternatively, a more formal test can be conducted as follows. Two grams of gum is chewed or manually kneaded under water for 20 minutes to produce a cud. The cud is then immediately placed on a concrete paver stone and covered with silicone coated paper. 150 to 200 pounds of pressure is applied to the cud (for example by stepping on it with a flat soled shoe) for approximately two seconds. In an even more rigorous test, the cud may be stepped on 200 times to simulate foot traffic over a period of days or weeks.) The silicone-coated paper is then removed and the adhered cud and paver stone are conditioned at 45° C./60% RH for 48 hours. A flat-edged metal scraper held at a 15° angle is used to make a single scrape of the cud over approximately three to five seconds. The results are then evaluated using image analysis software, such as ImageJ 1.43u from the National Institutes of Health, to measure the portion of the cud remaining. Readily removable cuds will leave no more than 20% of the original mass as residue and require no more than approximately 50 N of force. Of course, it is desirable that the cud leave even less residue and require less force to remove.

In some embodiments, the block polymer or block/di- and/or tri-block polymer blend (hereinafter the block polymer elastomer system) will be the sole component of the insoluble gum base. In other embodiments, the block polymer or block polymer elastomer system will be combined with softeners, fillers, colors, antioxidants and other conventional gum base components. In some embodiments, the block polymer or block polymer elastomer system gum bases may be used to replace conventional gum bases in chewing gum formulas which additionally contain water-soluble bulking agents, flavors, high-intensity sweeteners, colors, pharmaceutical or nutraceutical agents and other optional ingredients. These chewing gums may be formed into sticks, tabs, tapes, coated or uncoated pellets or balls or any other desired form. By substituting the block polymer or block polymer elastomer system of the present invention for a portion or all of the conventional gum base elastomers, consumer—acceptable chewing gum products can be manufactured which exhibit reduced adhesion to environmental surfaces, especially concrete.

In order to further enhance the removability of cuds formed from gum bases comprising the block polymer systems of the present invention, it may be desirable to incorporate other known removability-enhancing features into the chewing gum or gum base. For example, certain additives such as emulsifiers and amphiphilic polymers may be added. Another additive which may prove useful is a polymer having a straight or branched chain carbon-carbon polymer backbone and a multiplicity of side chains attached to the backbone as disclosed in WO 06-016179. Still another additive which may enhance removability is a polymer comprising hydrolyzable units or an ester and/or ether of such a polymer. One such polymer comprising hydrolyzable units is a copolymer sold under the Trade name Gantrez®. Addition of such polymers at levels of 1 to 20% by weight of the gum base may reduce adhesion of discarded gum cuds. These polymers may also be added to the gum mixer at a level of 1 to 7% by weight of the chewing gum composition.

Another gum base additive which may enhance removability of gum cuds is high molecular weight polyvinyl acetate having a molecular weight of 100,000 to 600,000 daltons as disclosed in US 2003/0198710. This polymer may be used at levels of 7 to 70% by weight of the gum base. High molecular weight polyvinyl laurate may perform similarly.

Another approach to enhancing removability of the present invention involves formulating gum bases to contain less than 5% (i.e. 0 to 5%) or less than 10% of a non-silica filler such as a calcium carbonate and/or talc filler and/or 5 to 40% amorphous silica filler. Formulating gum bases to contain 5 to 15% of high molecular weight polyisobutylene (for example, polyisobutylene having a weight average or number average molecular weight of at least 200,000 daltons) is also effective in enhancing removability. High levels of emulsifiers such as powdered lecithin may be incorporated into the chewing gum at levels of 3 to 7% by weight of the chewing gum composition. It may be advantageous to spray dry or otherwise encapsulate the emulsifier to delay its release. Any combination of the above approaches may be employed simultaneously to achieve improved removability. Specifically, removability can be enhanced by incorporating a block polymer or block polymer elastomer system as previously described into a gum base having 0 to 5% of a calcium carbonate or talc filler, 5 to 40% amorphous silica filler, 5 to 15% high molecular weight polyisobutylene, 1 to 20% of a polymer having a straight or branched chain carbon-carbon polymer backbone and a multiplicity of side chains attached to the backbone and further incorporating this gum base into a chewing gum comprising 3 to 7% of an emulsifier, such as lecithin, which is preferably encapsulated such as by spray drying. Many variations on this multi-component solution to the cud adhesion problem can be employed. For example, the polymer having a straight or branched chain carbon-carbon polymer backbone or the ester and/or ether of a polymer comprising hydrolyzable units may be added to the gum mixer instead of incorporating it into the gum base, in which case it may be employed at a level of 1 to 7% of the chewing gum composition. Also, in some cases it may be desirable to omit one or more of the above components for various reasons.

Yet another approach to improving removability is to incorporated softeners or plasticizers which will leach out of the gum cud after it is discarded. This can cause the cud to become more cohesive and rigid allowing it to be popped off adhered substrates. The leaching plasticizer may also form a weak adhesive layer between the cud and the substrate further enhancing removability.

The block polymer or block polymer elastomer system, when used according to the present invention, affords the chewing gum consumer acceptable texture, shelf life and flavor quality. Because the block polymer or block polymer elastomer systems have chewing properties similar to other elastomers in most respects, gum bases containing them create a resultant chewing gum product that has a high consumer-acceptability.

The present invention provides in some embodiments gum base and chewing gum manufacturing processes which have improved efficiency as compared with conventional processes.

Additional features and advantages of the present invention are described in, and will be apparent from, the detailed description of the presently preferred embodiments.

When a block polymer and a di- and/or tri-block polymer are used as a modifier in a block polymer elastomer system, it is preferred that the two components be used in a ratio of from 1:99 to 99:1 modifier:multiblock elastomer and more preferably 40:60 to 95:5 modifier:multiblock elastomer to assure that the resulting block polymer elastomer system will have proper texture for processing and chewing. The block polymers may also be plasticized with a conventional plasticizing agent to form an elastomeric material which, when formulated as a gum base, has sufficient chewing cohesion to be cud-forming and chewable at mouth temperatures. Plasticizers typically function to lower the T_{g} of a polymer to make the gum cud chewable at mouth temperature. Suitable plasticizers typically are also capable of decreasing the shear modulus of the base. Suitable plasticizing agents are substances of relatively low molecular weight which have a solubility parameter similar to the polymer so they are capable of intimately mixing with the polymer and reducing the T_{g} of the mixture to a value lower than the polymer alone. Generally, any food acceptable plasticizer which functions to soften the block polymer and render it chewable at mouth temperature will be a suitable plasticizer. Plasticizers which may be used in the present invention include triacetin, phospholipids such as lecithin and phosphatidylcholine, triglycerides of C₄-C₆ fatty acid such as glycerol trihexanoate, polyglycerol, polyricinoleate, propylene glycol di-octanoate, propylene glycol di-decanoate, triglycerol penta-caprylate, triglycerol penta-caprate, decaglyceryl hexaoleate, decaglycerol decaoleate, citric acid esters of mono- or di-glycerides, polyoxyethylene sorbitan such as POE (80) sorbitan monolaurate, POE (20) sorbitan monooleate, rosin ester and polyterpene resin. Certain flavors may also serve as plasticizers.

Fats, waxes and acetylated monoglycerides can enhance the effect of the suitable plasticizers when incorporated into the gum bases of the present invention. However, fats and waxes may not be suitable for use as the sole plasticizers in these compositions.

It is preferred that the block polymer be preblended with the diblock or triblock polymer or other plasticizer, for example by blending in a solvent, or by using mechanical blending at temperatures above the highest glass transition temperature of the block polymer or by polymerizing the di- and block polymers in situ.

The water-insoluble gum base of the present invention may optionally contain conventional petroleum-based elastomers and elastomer plasticizers such as styrene-butadiene rubber, butyl rubber, polyisobutylene, terpene resins and estergums. Where used, these conventional elastomers may be combined in any compatible ratio with the block polymer. In a preferred embodiment, significant amounts (more than 1 wt. %) of these conventional elastomers and elastomer plasticizers are not incorporated into a gum base of the present invention. In other preferred embodiments, less than 15 wt. % and preferably less than 10 wt. % and more preferably less than 5 wt. % of petroleum-based elastomers and elastomer plasticizers are contained in the gum base of the present invention. Other ingredients which may optionally be employed include inorganic fillers such as calcium carbonate and talc, emulsifiers such as lecithin and mono- and di-glycerides, plastic resins such as polyvinyl acetate, polyvinyl laurate, and vinylacetate/vinyl laurate copolymers, colors and antioxidants.

The water-insoluble gum base of the present invention may constitute from about 5 to about 95% by weight of the chewing gum. More typically it may constitute from about 10 to about 50% by weight of the chewing gum and, in various preferred embodiments, may constitute from about 20 to about 35% by weight of the chewing gum.

A typical gum base useful in this invention includes about 5 to 100 wt. % plasticized block polymer elastomer, 0 to 20 wt. % synthetic elastomer, 0 to 20 wt. % natural elastomer, about 0 to about 40% by weight elastomer solvent, about 0 to about 35 wt. % filler, about 0 to about 35 wt. % softener, about 0 to about 45% plastic resin and optional minor amounts (e.g., about 1 wt. % or less) of miscellaneous ingredients such as colorants, antioxidants, and the like.

Further, a typical gum base includes at least 5 wt. % and more typically at least 10 wt. % softener and includes up to 35 wt. % and more typically up to 30 wt. % softener. Still further, a typical gum base includes 5 to 40 wt. % and more typically 15 to 30 wt. % hydrophilic modifier such as polyvinylacetate. Minor amounts (e.g., up to about 1 wt. %) of miscellaneous ingredients such as colorants, antioxidants, and the like also may be included into such a gum base.

In an embodiment, a chewing gum base of the present invention contains about 4 to about 35 weight percent filler, about 5 to about 35 weight percent softener, about 5 to about 40% hydrophilic modifier and optional minor amounts (about one percent or less) of miscellaneous ingredients such as colorants, antioxidants, and the like.

Additional elastomers may include, but are not limited to, polyisobutylene having a viscosity average molecular weight of about 100,000 to about 800,000, isobutylene-isoprene copolymer (butyl elastomer), polyolefin thermoplastic elastomers such as ethylene-propylene copolymer and ethylene-octene copolymer, styrene-butadiene copolymers having styrene-butadiene ratios of about 1:3 to about 3:1 and/or polyisoprene, and combinations thereof. Natural elastomers which may be similarly incorporated into the gum bases of the present inventions include jelutong, lechi caspi, perillo, sorva, massaranduba balata, massaranduba chocolate, nispero, rosindinha, chicle, gutta hang kang, and combinations thereof.

The elastomer component of gum bases used in this invention may contain up to 100 wt. % block polymer. In some embodiments, the block polymers of the present invention may be combined with compatible plasticizers (including diblock polymers as previously described) and the plasticized copolymer system may be used as the sole components of a gum base. Alternatively, mixtures of plasticized or unplasticized block polymers with other elastomers also may be used. In such embodiments, mixtures with conventional elastomeric components of gum bases may comprise least 10 wt. % plasticized or unplasticized block polymer, typically at least 30 wt. % and preferably at least 50 wt. % of the elastomer. In order to provide for improved removability of discarded gum cuds form environmental surfaces, gum bases of the present invention will contain an elastomeric component which comprises at least 10%, preferably at least 30%, more preferably at least 50% and up to 100 wt. % plasticized or unplasticized block polymer in addition to other non-elastomeric components which may be present in the gum base. Due to cost limitations, processing requirements, sensory properties and other considerations, it may be desirable to limit the elastomeric component of the gum base to no more than 90%, or 75% or 50% plasticized or unplasticized block polymer.

A typical gum base containing block polymers of the present invention may have a complex shear modulus (the measure of the resistance to the deformation) of 1 kPa to 10,000 kPa at 40° C. (measured on a Rheometric Dynamic Analyzer with dynamic temperature steps, 0-100° C. at 3° C./min; parallel plate; 0.5% strain; 10 rad/sec). Preferably, the complex shear modulus will be between 10 kPa and 1000 kPa at the above conditions. Gum bases having shear modulus in these ranges have been found to have acceptable chewing properties.

A suitable block polymer used in this invention typically should be free of strong, undesirable off-tastes (i.e. objectionable flavors which cannot be masked) and have an ability to incorporate flavor materials which provide a consumer-acceptable flavor sensation. Suitable block polymers should also be safe and food acceptable, i.e. capable of being food approved by government regulatory agencies for use as a masticatory substance, i.e. chewing gum base. Furthermore, it is preferable that the polymers be prepared using only food safe catalysts, reagents and solvents.

Typically, the block polymers of the present invention have sufficient chewing cohesion such that a chewing gum composition containing such material forms a discrete gum cud with consumer acceptable chewing characteristics.

Elastomer plasticizers commonly used for petroleum-based elastomers may be optionally used in this invention including but are not limited to, natural rosin esters, often called estergums, such as glycerol esters of partially hydrogenated rosin, glycerol esters of polymerized rosin, glycerol esters of partially or fully dimerized rosin, glycerol esters of rosin, pentaerythritol esters of partially hydrogenated rosin, methyl and partially hydrogenated methyl esters of rosin, pentaerythritol esters of rosin, glycerol esters of wood rosin, glycerol esters of gum rosin; synthetics such as terpene resins derived from alpha-pinene, beta-pinene, and/or d-limonene; and any suitable combinations of the foregoing. The preferred elastomer plasticizers also will vary depending on the specific application, and on the type of elastomer which is used.

In addition to natural rosin esters, also called resins, elastomer solvents may include other types of plastic resins. These include polyvinyl acetate having a GPC weight average molecular weight of about 2,000 to about 90,000, polyethylene, vinyl acetate-vinyl laurate copolymer having vinyl laurate content of about 5 to about 50 percent by weight of the copolymer, and combinations thereof. Preferred weight average molecular weights (by GPC) for polyisoprene are 50,000 to 80,000 and for polyvinyl acetate are 10,000 to 65,000 (with higher molecular weight polyvinyl acetates typically used in bubble gum base). For vinyl acetate-vinyl laurate, vinyl laurate content of 10-45 percent by weight of the copolymer is preferred. Preferably, a gum base contains a plastic resin in addition to other materials functioning as elastomer plasticizers.

Additionally, a gum base may include fillers/texturizers and softeners/emulsifiers. Softeners (including emulsifiers) are added to chewing gum in order to optimize the chewability and mouth feel of the gum.

Softeners/emulsifiers that typically are used include tallow, hydrogenated tallow, hydrogenated and partially hydrogenated vegetable oils, cocoa butter, mono- and di-glycerides such as glycerol monostearate, glycerol triacetate, lecithin, paraffin wax, microcrystalline wax, natural waxes and combinations thereof. Lecithin and mono- and di-glycerides also function as emulsifiers to improve compatibility of the various gum base components.

Fillers/texturizers typically are inorganic, water-insoluble powders such as magnesium and calcium carbonate, ground limestone, silicate types such as magnesium and aluminum silicate, clay, alumina, talc, titanium oxide, mono-, di- and multi-calcium phosphate and calcium sulfate. Insoluble organic fillers including cellulose polymers such as wood as well as combinations of any of these also may be used.

Selection of various components in chewing gum bases or chewing gum formulations of this invention typically are dictated by factors, including for example the desired properties (e.g., physical (mouthfeel), taste, odor, and the like) and/or applicable regulatory requirements (e.g., in order to have a food grade product, food grade components, such as food grade approved oils like vegetable oil, may be used.)

Colorants and whiteners may include FD&C-type dyes and lakes, fruit and vegetable extracts, titanium dioxide, and combinations thereof.

Antioxidants such as BHA, BHT, tocopherols, propyl gallate and other food acceptable antioxidants may be employed to prevent oxidation of fats, oils and elastomers in the gum base.

As noted, the base may include wax or be wax-free. An example of a wax-free gum base is disclosed in U.S. Pat. No. 5,286,500, the disclosure of which is incorporated herein by reference.

A water-insoluble gum base typically constitutes approximately 5 to about 95 percent, by weight, of a chewing gum of this invention; more commonly, the gum base comprises 10 to about 50 percent of a chewing gum of this invention; and in some preferred embodiments, 20 to about 35 percent, by weight, of such a chewing gum.

In addition to a water-insoluble gum base portion, a typical chewing gum composition includes a water-soluble bulk portion (or bulking agent) and one or more flavoring agents. The water-soluble portion can include high intensity sweeteners, binders, flavoring agents (which may be water insoluble), water-soluble softeners, gum emulsifiers, colorants, acidulants, fillers, antioxidants, and other components that provide desired attributes.

Water-soluble softeners, which may also known as water-soluble plasticizers and plasticizing agents, generally constitute between approximately 0.5 to about 15% by weight of the chewing gum. Water-soluble softeners may include glycerin, lecithin, and combinations thereof. Aqueous sweetener solutions such as those containing sorbitol, hydrogenated starch hydrolysates (HSH), corn syrup and combinations thereof, may also be used as softeners and binding agents (binders) in chewing gum.

Preferably, a bulking agent or bulk sweetener will be useful in chewing gums of this invention to provide sweetness, bulk and texture to the product. Typical bulking agents include sugars, sugar alcohols, and combinations thereof. Bulking agents typically constitute from about 5 to about 95% by weight of the chewing gum, more typically from about 20 to about 80% by weight and, still more typically, from about 30 to about 70% by weight of the gum. Sugar bulking agents generally include saccharide containing components commonly known in the chewing gum art, including, but not limited to, sucrose, dextrose, maltose, dextrin, dried invert sugar, fructose, levulose, galactose, corn syrup solids, and the like, alone or in combination. In sugarless gums, sugar alcohols such as sorbitol, maltitol, erythritol, isomalt, mannitol, xylitol and combinations thereof are substituted for sugar bulking agents. Combinations of sugar and sugarless bulking agents may also be used.

In addition to the above bulk sweeteners, chewing gums typically comprise a binder/softener in the form of a syrup or high-solids solution of sugars and/or sugar alcohols. In the case of sugar gums, corn syrups and other dextrose syrups (which contain dextrose and significant amounts higher saccharides) are most commonly employed. These include syrups of various DE levels including high-maltose syrups and high fructose syrups. In the case of sugarless products, solutions of sugar alcohols including sorbitol solutions and hydrogenated starch hydrolysate syrups are commonly used. Also useful are syrups such as those disclosed in U.S. Pat. No. 5,651,936 and US 2004-234648 which are incorporated herein by reference. Such syrups serve to soften the initial chew of the product, reduce crumbliness and brittleness and increase flexibility in stick and tab products. They may also control moisture gain or loss and provide a degree of sweetness depending on the particular syrup employed. In the case of syrups and other aqueous solutions, it is generally desirable to use the minimum practical level of water in the solution to the minimum necessary to keep the solution free-flowing at acceptable handling temperatures. The usage level of such syrups and solutions should be adjusted to limit total moisture in the gum to less than 3 wt. %, preferably less than 2 wt. % and most preferably less than 1 wt. %.

High intensity artificial sweeteners can also be used in combination with the above-described sweeteners. Preferred sweeteners include, but are not limited to sucralose, aspartame, salts of acesulfame, alitame, neotame, saccharin and its salts, cyclamic acid and its salts, glycyrrhizin, stevia and stevia compounds such as rebaudioside A, dihydrochalcones, thaumatin, monellin, lo han guo and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extrusion may be used to achieve the desired release characteristics.

Usage level of the artificial sweetener will vary greatly and will depend on such factors as potency of the sweetener, rate of release, desired sweetness of the product, level and type of flavor used and cost considerations. Thus, the active level of artificial sweetener may vary from 0.02 to about 8% by weight. When carriers used for encapsulation are included, the usage level of the encapsulated sweetener will be proportionately higher.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Examples of low caloric bulking agents include: polydextrose; Raftilose, Raftilin; fructooligosaccharides (NutraFlora); Palatinose oligosaccharide; Guar Gum Hydrolysate (Sun Fiber); or indigestible dextrin (Fibersol). However, other low calorie bulking agents can be used. In addition, the caloric content of a chewing gum can be reduced by increasing the relative level of gum base while reducing the level of caloric sweeteners in the product. This can be done with or without an accompanying decrease in piece weight.

A variety of flavoring agents can be used. The flavor can be used in amounts of approximately 0.1 to about 15 weight percent of the gum, and preferably, about 0.2 to about 5%. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion. Sensate components which impart a perceived tingling or thermal response while chewing, such as a cooling or heating effect, also may be included. Such components include cyclic and acyclic carboxamides, menthol derivatives, and capsaicin among others. Acidulants may be included to impart tartness.

In addition to typical chewing gum components, chewing gums of the present invention may include active agents such as dental health actives such as minerals, nutritional supplements such as vitamins, health promoting actives such as antioxidants for example resveratrol, stimulants such as caffeine, medicinal compounds and other such additives. These active agents may be added neat to the gum mass or encapsulated using known means to prolong release and/or prevent degradation. The actives may be added to coatings, rolling compounds and liquid or powder fillings where such are present.

It may be desirable to add components to the gum or gum base composition which enhance environmental degradation of the chewed cud after it is chewed and discarded. For example, an enzyme capable of attacking one or more of the polymeric components (such as one or more of the polymeric blocks in the block polymer) may be added to the chewing gum formula. In the case of a polyester, an esterase enzyme may be added to accelerate decomposition of the polymer. Alternatively, proteinases such as proteinase K, pronase, and bromelain can be used to degrade poly(lactic acid) and cutinases may be used to degrade poly(6-methyl-ε-caprolactone) and/or poly (ε-caprolactone). Such enzymes may be available from Valley Research, Novozymes, and other suppliers. Optionally, the enzyme or other degradation agent may be encapsulated by spray drying, fluid bed encapsulation or other means to delay the release and prevent premature degradation of the cud. It is also possible to immobilize an enzyme into a gum or gum base by grafting it on to a polymer or filler in the gum or gum base to provide extended degradation action which may be necessary to sufficiently control degradation of the block polymer. Typically, immobilization or grafting is accomplished using glutaraldehyde, oxidized dextran, or some other cross-linking agent with reactivity to chemical functional groups on either the enzyme or the substrate of interest. The degradation agent (whether free, encapsulated or immobilized) may be used in compositions employing block polymers and block polymer elastomer systems as well as the multi-component systems previously described to further reduce the problems associated with improperly discarded gum cuds.

The present invention may be used with a variety of processes for manufacturing chewing gum including batch mixing, continuous mixing and tableted gum processes.

Chewing gum bases of the present invention may be easily prepared by combining the block polymer with a suitable plasticizer as previously disclosed. If additional ingredients such as softeners, plastic resins, emulsifiers, fillers, colors and antioxidants are desired, they may be added by conventional batch mixing processes or continuous mixing processes. Process temperatures are generally from about 60° C. to about 130° C. in the case of a batch process. If it is desired to combine the plasticized block polymer with conventional elastomers, it is preferred that the conventional elastomers be formulated into a conventional gum base before combining with the block polymer gum base. To produce the conventional gum base, the elastomers are first ground or shredded along with filler. Then the ground elastomer is transferred to a batch mixer for compounding. Essentially any standard, commercially available mixer known in the art (e.g., a Sigma blade mixer) may be used for this purpose. The first step of the mixing process is called compounding. Compounding involves combining the ground elastomer with filler and elastomer plasticizer (elastomer solvent). This compounding step generally requires long mixing times (30 to 70 minutes) to produce a homogeneous mixture. After compounding, additional filler and elastomer plasticizer are added followed by PVAc and finally softeners while mixing to homogeneity after each added ingredient. Minor ingredients such as antioxidants and color may be added at any time in the process. The conventional base is then blended with the block polymer base in the desired ratio. Whether the block polymer is used alone or in combination with conventional elastomers, the completed base is then extruded or cast into any desirable shape (e.g., pellets, sheets or slabs) and allowed to cool and solidify.

Alternatively, continuous processes using mixing extruders, which are generally known in the art, may be used to prepare the gum base. In a typical continuous mixing process, initial ingredients (including ground elastomer, if used) are metered continuously into extruder ports various points along the length of the extruder corresponding to the batch processing sequence. After the initial ingredients have massed homogeneously and have been sufficiently compounded, the balance of the base ingredients are metered into ports or injected at various points along the length of the extruder. Typically, any remainder of elastomer component or other components are added after the initial compounding stage. The composition is then further processed to produce a homogeneous mass before discharging from the extruder outlet. Typically, the transit time through the extruder will be substantially less than an hour. If the gum base is prepared from block polymer without conventional elastomers, it may be possible to reduce the necessary length of the extruder needed to produce a homogeneous gum base with a corresponding reduction in transit time. In addition, the block polymer need not be pre-ground before addition to the extruder. It is only necessary to ensure that the block polymer is reasonably free-flowing to allow controlled, metered feeding into the extruder inlet port.

Exemplary methods of extrusion, which may optionally be used in conjunction with the present invention, include the following, the entire contents of each being incorporated herein by reference: (i) U.S. Pat. No. 6,238,710, claims a method for continuous chewing gum base manufacturing, which entails compounding all ingredients in a single extruder; (ii) U.S. Pat. No. 6,086,925 discloses the manufacture of chewing gum base by adding a hard elastomer, a filler and a lubricating agent to a continuous mixer; (iii) U.S. Pat. No. 5,419,919 discloses continuous gum base manufacture using a paddle mixer by selectively feeding different ingredients at different locations on the mixer; and, (iv) yet another U.S. Pat. No. 5,397,580 discloses continuous gum base manufacture wherein two continuous mixers are arranged in series and the blend from the first continuous mixer is continuously added to the second extruder.

Chewing gum is generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, tabs or pellets or by extruding and cutting into chunks.

Generally, the ingredients are mixed by first softening or melting the gum base and adding it to the running mixer. The gum base may alternatively be softened or melted in the mixer. Color and emulsifiers may be added at this time.

A chewing gum softener such as glycerin can be added next along with part of the bulk portion. Further parts of the bulk portion may then be added to the mixer. Flavoring agents are typically added with the final part of the bulk portion. The entire mixing process typically takes from about five to about fifteen minutes, although longer mixing times are sometimes required.

In yet another alternative, it may be possible to prepare the gum base and chewing gum in a single high-efficiency extruder as disclosed in U.S. Pat. No. 5,543,160. Chewing gums of the present invention may be prepared by a continuous process comprising the steps of: a) adding gum base ingredients into a high efficiency continuous mixer; b) mixing the ingredients to produce a homogeneous gum base, c) adding at least one sweetener and at least one flavor into the continuous mixer, and mixing the sweetener and flavor with the remaining ingredients to form a chewing gum product; and d) discharging the mixed chewing gum mass from the single high efficiency continuous mixer. In the present invention, it may be necessary to first blend the block polymer with a suitable plasticizer before incorporation of additional gum base or chewing gum ingredients. This blending and compression process may occur inside the high-efficiency extruder or may be performed externally prior to addition of the plasticized block polymer composition to the extruder.

Of course, many variations on the basic gum base and chewing gum mixing processes are possible.

After mixing, the chewing gum mass may be formed, for example by rolling or extruding into and desired shape such as sticks, tabs, chunks or pellets. The product may also be filled (for example with a liquid syrup or a powder) and/or coated for example with a hard sugar or polyol coating using known methods.

After forming, and optionally filling and/or coating, the product will typically be packaged in appropriate packaging materials. The purpose of the packaging is to keep the product clean, protect it from environmental elements such as oxygen, moisture and light and to facilitate branding and retail marketing of the product.

### EXAMPLES

### Example 1

An (ABA)ₙ multiblock copolymer was prepared using α,ω-dihydroxyl ABA triblock polymer and a coupling agent, which converted the α,ω-dihydroxyl functional groups of ABA triblock copolymer to linking groups. The coupling reaction for poly(DL-lactide-b-1,4-isoprene-b-DL-lactide) (LIL) triblock polymer with α,ω-dihydroxyl groups synthesized using anionic and ring-opening polymerization techniques is shown below:

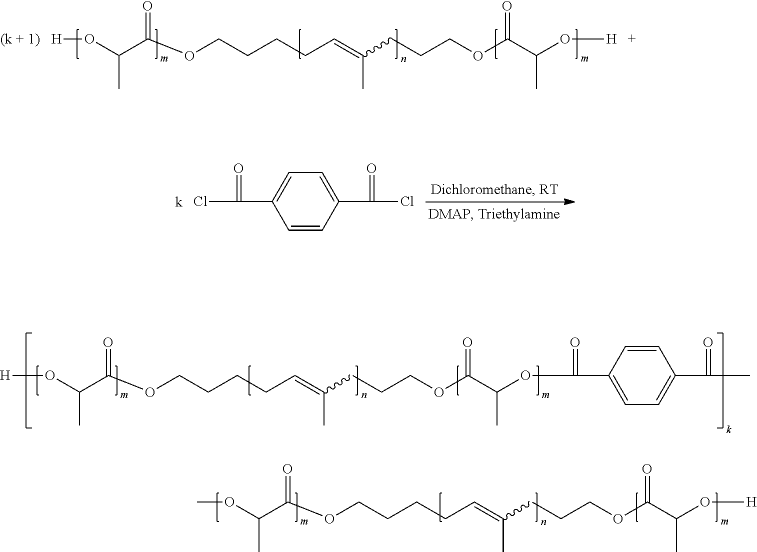

The coupling agent, terephthaloyl dichloride, and acid scavengers, triethylamine and 4-dimethylaminopyridine (DMAP), are commercially available. The following synthesis was carried out at 25° C. LIL-6 triblock copolymer (0.77 mmol) and excess triethylamine and DMAP (10 molar equivalent to LIL-6) were dissolved in anhydrous dichloromethane (50 ml) under dry nitrogen atmosphere. The coupling agent, terephthaloyl dichloride (0.77 mmol) dissolved in dichloromethane (10 ml) was slowly added to the LIL-6 solution with stirring using an additional funnel for 1 hour, then the coupling solution was further stirred for 2 hours. The polymer solution was precipitated in methanol for purification, and multiblock copolymer, (LIL)ₘ-3 was recovered and dried under dynamic vacuum.

The above block polymer can be used to prepare gum bases and chewing gums which are expected to exhibit improved removability from concrete under a range of common environmental conditions.

### Example 2

A triblock poly (lactide)-poly (ε-caprolactone)-poly (lactide) polymer was prepared as follows. In a nitrogen filled glove box, ε-decalactone (10.08 g, 59.23 mmol), Sn(Oct)₂ (24.30 mg, 59.98 μmol), and 1,4-benzenedimethanol (348.10 mg, 2.52 mmol) were added to a 48 mL pressure vessel. The sealed reaction vessel was removed from the glove box and placed in a 180° C. oil bath for 2 hours. The vessel was then removed from the oil bath and allowed to cool to room temperature. Following the addition of D,L-lactide (11.12 g, 77.14 mmol) and toluene (15.28 g) the reaction mixture was heated to 110° C. for 4 hours and cooled to room temperature. Approximately 10 g of the reaction mixture were diluted in chloroform and precipitated in methanol to afford L_{2.5}D_{4.5}L_{2.5}, and 6.5709 g of the mixture was used to make (L_{2.5}D_{4.5}L_{2.5})ₙ (Example 3) where the subscripts denote Mₙ in kg/mol,

### Example 3

A multi-block polymer was prepared as follows. To the crude reaction mixture from Example 2 L_{2.5}D_{4.5}L_{2.5} (6.5709 g, 3.818 g monomers, 0.304 mmol of 1,4-benzenedimethanol) 4,4′-methylenebis(phenyl isocyanate) (804 mg, 3.21 mmol) was added and heated to 110° C. for 10 min before cooling back to room temperature. The reaction mixture was then dissolved in chloroform and precipitated in methanol to provide (L_{2.5}D_{4.5}L_{2.5})ₙ.

### Example 4

A multi-block polymer was prepared as follows. In a nitrogen filled glove box, ε-decalactone (18.30 g, 107.49 mmol), Sn(Oct)₂ (44.60 mg, 110 μmol), and 1,4-benzenedimethanol (265.4 mg, 1.92 mmol) were added to a 48 mL pressure vessel. The sealed reaction vessel was removed from the glove box and placed in a 180° C. oil bath for 2 hours. The vessel was then removed from the oil bath and allowed to cool to room temperature. A portion of the reaction mixture (15.68 g) was transferred to a three-neck round bottom flask equipped with an overheat stirrer and an argon gas inlet. Following the addition of D,L-lactide (8.4631 g, 58.7 mmol) the neat reaction mixture was heated to 130° C. for 2 hours and cooled to room temperature. The temperature was changed to 110° C. and 4,4′-methylenebis(phenyl isocyanate) (405.7 mg, 1.62 mmol) was added. After approximately 1 minute the increase in viscosity nearly stopped the mechanical stirrer's rotation, so stirring was stopped. After 10 min the reaction was cooled to room temperature. The reaction mixture was then dissolved in chloroform and precipitated in methanol to yield (L_{2.2}D_{9.1}L_{2.2})ₙ.

### Comparative Examples 5 and 6

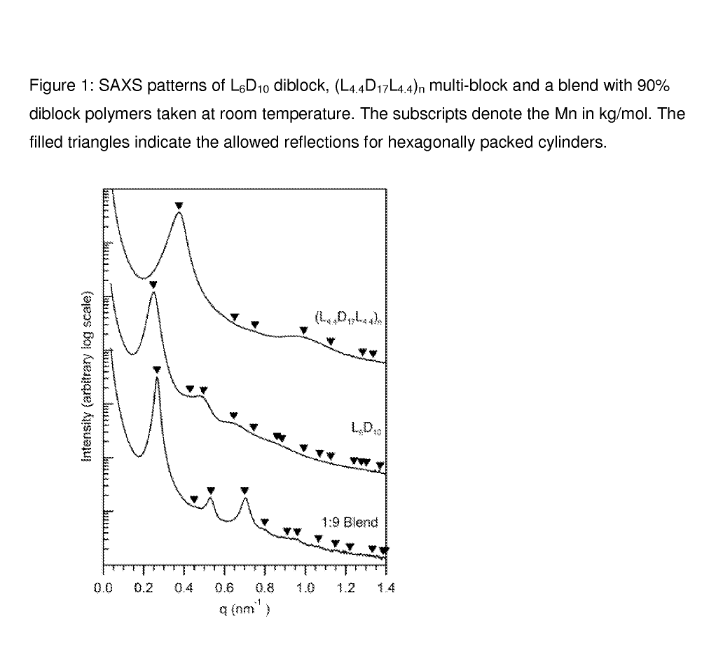

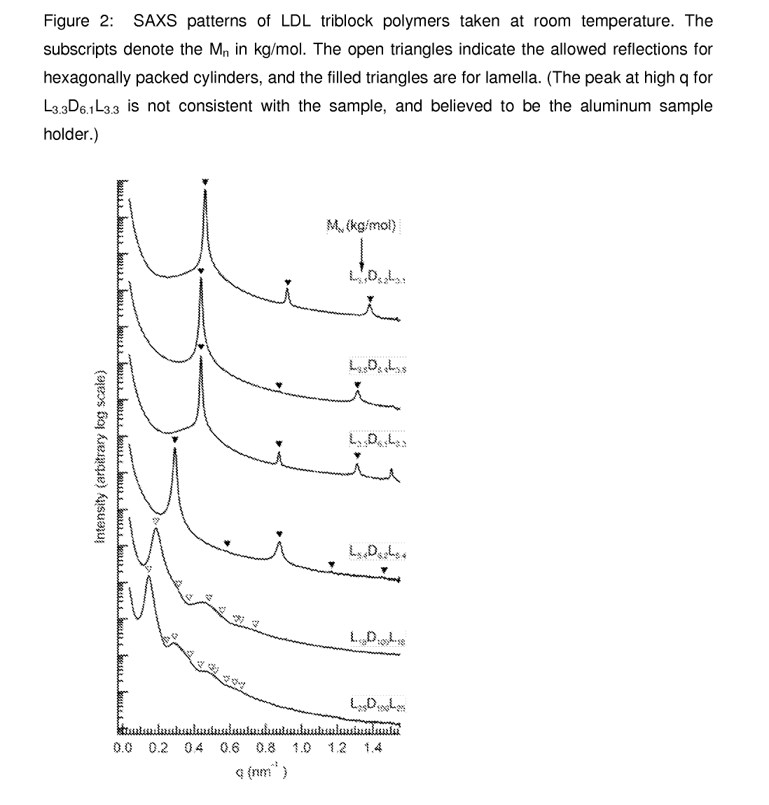

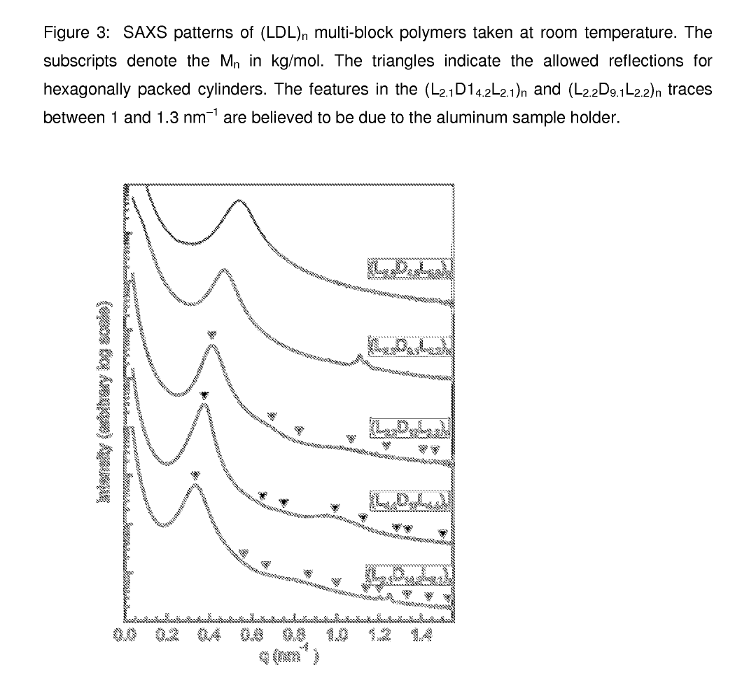

High molar mass triblock poly (lactide)-poly (ε-caprolactone)-poly (lactide) polymer, L₁₈D₁₀₀L₁₈ (Comparative Example 5) and L₂₅D₁₀₀L₂₅ (Comparative Example 6) were analyzed by Small Angle X-Ray Scattering (SAXS) at room temperature. These block polymers exhibited scattering profiles consistent with cylinders of L hexagonally packed in a matrix of D. The indexed scattering profile is shown as FIG. 1. Tri-block polymers with accessible ODT temperatures (f_{A}≈0.5) used to determine the segment-segment interaction parameter were also characterized by SAXS. The scattering peaks of these triblock polymers were well correlated to the lamellar morphology. The calculated T_{ODT} for L₁₈D₁₀₀L₁₈ and L₂₅D₁₀₀L₂₅ was greater than 600° C. for both triblock polymers.

Using the χ_{L/D} determined from the T_{ODT}s of LDL triblock polymers, several (LDL)ₙ multi-block polymers were prepared targeting T_{ODT}s close to 100° C. The T_{ODT} was approximated based on the χN(f_{A}) bounding the ordered and disordered regions of the theoretical phase diagram published by Matsen (Macromolecules 2012, 45 (4), 2161-2165). A low MW multi-block polymer, (L_{2.6}D_{4.8}L_{2.6})ₙ f_{L}=0.46, showed some evidence of an ODT at 70° C. by SAOS rheology, but the SAXS profile taken at room temperature did not support a microphase separated structure. The multi-block polymers (L_{2.2}D_{9.1}L_{2.2})ₙ f_{L}=0.27 and (L_{2.2}D₁₂L_{2.2})ₙ f_{L}=0.22 also showed evidence of an ODT at 110 and 112° C., respectively, by SAOS and showed some features in their SAXS profiles consistent with cylinders. A frequency sweep of (L_{2.2}D_{9.1}L_{2.2})ₙ taken at 90° C. exhibited solid like behavior, but at 150° C. terminal behavior was observed at the low frequencies. (L_{2.2}D₁₂L_{2.2})ₙ also showed terminal behavior at 150° C. A similar multi-block polymer was scaled up yielding 180 g of (L_{2.1}D₁₄L_{2.1})ₙ f_{L}=0.19) to provide enough material to complete a battery of mechanical tests.

The copolymerization of ε-decalactone (DL) with ε-caprolactone (CL) was studied with the goal of producing an amorphous polyester rubber. The copolymerization conditions (bulk, Sn(Oct)₂, 180° C.) were similar to the conditions used to make the previously described multi-block polymers. Due to the reactivity of CL the catalyst loading for the copolymerization was much lower.

### Examples 7 and 8

Gum bases having multiblock elastomer systems were prepared using a triblock poly (lactide)-poly (ε-caprolactone)-poly (lactide) polymer (LDL) having Mₙ of approximately 131,000 daltons and a polylactide content of approximately 37%, and a diblock poly (lactide)-poly (ε-caprolactone) polymer (LD) having Mₙ of approximately 17,500 daltons and a polylactide content of approximately 37% according to the formulas in Table 1:

TABLE 1

| | Example 7 | Example 8 |
|---|---|---|
| LDL | 63.3 | 12.7 |
| LD | — | 50.6 |
| PVAc (Mₙ ~15,000 Da) | 31.7 | 31.7 |
| Calcium Carbonate | 5.0 | 5.0 |
| Total | 100.00 | 100.00 |

In Example 8, the LDL and LD were preblended. In both examples, the multi-block elastomer system was mixed in a Brabender mixer with the polyvinyl acetate for a minute or two before adding the calcium carbonate and continuing to mix for a total of 15 minutes.

### Examples 9 and 10

Chewing gums were made from the Gum Bases of Examples 7 and 8 according to the formulas in Table 2.

TABLE 2

| | Example 9 | Example 10 |
|---|---|---|
| Sorbitol | 42.73 | 42.73 |
| Gum Base of Ex. 7 | 33.54 | — |
| Gum Base of Ex. 8 | — | 33.54 |
| Calcium Carbonate | 9.46 | 9.46 |
| Acetylated Monoglycerides | 4.00 | 4.00 |
| Glycerol Triacetate | 2.50 | 2.50 |
| Glycerin | 3.75 | 3.75 |
| Peppermint Flavor | 2.72 | 2.72 |
| Encapsulated High Intensity Sweetener | 1.30 | 1.30 |
| Total | 100.00 | 100.00 |

1. A chewing gum base comprising a block polymer comprising at least four blocks having at least two different monomer systems, the block polymer having an order-disorder transition temperature in the range of 20 to 250° C.

2. The chewing gum base of claim 1 wherein the block polymer has an order-disorder transition temperature less than 200° C.

3. The chewing gum base of claim 1 wherein the block polymer has an order-disorder transition temperature less than 180° C.

4. The chewing gum base of claim 1 wherein the block polymer has an order-disorder transition temperature less than 160° C.

5. The chewing gum base of claim 1 wherein the block polymer has an order-disorder transition temperature less than 140° C.

6. The chewing gum base of claim 1 wherein the block polymer has an order-disorder transition temperature less than 120° C.

7. A chewing gum base comprising a block polymer comprising at least four blocks having at least two different monomer systems, the block polymer having an order-disorder transition temperature in the range of 20 to 100° C.

8. The chewing gum base of claim 7 wherein the block polymer has an order-disorder transition temperature less than 90° C.

9. The chewing gum base of claim 7 wherein the block polymer has an order-disorder transition temperature less than 80° C.

10. The chewing gum base of claim 7 wherein the block polymer has an order-disorder transition temperature less than 70° C.

11. The chewing gum base of claim 7 wherein the block polymer has an order-disorder transition temperature less than 60° C.

12. The chewing gum base of claim 7 wherein the block polymer has an order-disorder transition temperature less than 50° C.

13. The chewing gum base of claim 7 wherein the block polymer has an order-disorder transition temperature less than 40° C.

14. The chewing gum base of claim 1, wherein the block polymer has an order-disorder transition temperature greater than 25° C.

15. The chewing gum base of claim 14, wherein the block polymer has an order-disorder transition temperature greater than 30° C.

16. The chewing gum base of claim 14, wherein the block polymer has an order-disorder transition temperature greater than 35° C.

17. The chewing gum base of claim 1, wherein the order-disorder transition temperature is an effective order-disorder transition temperature as altered by a modifier.

18. The chewing gum base of claim 1, further comprising a modifier selected from a diblock copolymer, a triblock copolymer, or a combination thereof, the modifier comprising polymer blocks which are individually compatible with at least two of the blocks that make up the block polymer comprising at least four blocks.

19. A method of manufacturing a chewing gum piece comprising the steps of mixing chewing gum components to produce a chewing gum mass and forming the chewing gum mass into a final product shape, wherein at least one of the mixing and forming processes is conducted at a temperature greater than the order-disorder transition temperature of the block polymer.

20. The method of claim 19 further comprising the step of tempering the formed chewing gum piece at a temperature below the order-disorder transition temperature of the block polymer.
